(19) United States
(12) Patent Application Publication
(10) Pub. No.: US 2013/0017067 A1
(43) Pub. Date: Jan. 17, 2013

(54) METHOD OF BEAM WELDING OF AN IMPELLER WITH PERFORMANCE OF TWO PASSES ON A SLOT ; IMPELLER AND TURBO MACHINE HAVING SUCH WELD CONFIGURATION

(71) Applicants: Ugo Cantelli, Florence (IT); Enzo Miniati, Firenze (IT); Mirco Innocenti, Firenze (IT)

(72) Inventors: Ugo Cantelli, Florence (IT); Enzo Miniati, Firenze (IT); Mirco Innocenti, Firenze (IT)

(21) Appl. No.: 13/515,223

(22) PCT Filed: Dec. 7, 2010
(86) PCT No.: PCT/EP2010/069022

§ 371 Date: Oct. 5, 2012

(30) Foreign Application Priority Data
Dec. 11, 2009 (IT) CO2009A000063

(51) Int. Cl. F04D 29/28; F04D 29/056; B23K 15/00; B23P 15/00; B23K 26/20

(52) U.S. Cl. 415/170.1; 219/137 R; 219/121.64; 219/121.14; 416/179

(57) ABSTRACT

Systems and methods according to these exemplary embodiments provide welding techniques for impeller blades associated with impellers in centrifugal compressors. According to one exemplary embodiment, a connection area of the impeller blade has a “hammer”-shaped cross-sectional area which facilitates beam welding of the connection area to a slot in the surface or body to which the blade is to be connected.

### CROSS REFERENCE TO RELATED APPLICATIONS

This is a national stage application under 35 U.S.C. §371(c) of prior-filed, co-pending PCT patent application serial number EP10/069022, filed on Dec. 7, 2010, which claims priority to Italian Patent Application Serial No. CO2009A000063, filed on Dec. 11, 2009, the entire contents of which are incorporated herein by reference.

### BACKGROUND OF THE INVENTION

The present invention relates generally to compressors and, more specifically, to techniques for welding compressor impellers.

A compressor is a machine which accelerates gas particles to, ultimately, increase the pressure of a compressible fluid, e.g., a gas, through the use of mechanical energy. Compressors are used in a number of different applications, including operating as an initial stage of a gas turbine engine. Among the various types of compressors are the so-called centrifugal compressors, in which mechanical energy operates on gas input to the compressor by way of centrifugal acceleration, e.g., by rotating a centrifugal impeller (sometimes also called a “rotor”) by which the compressible fluid is passing. More generally, centrifugal compressors can be said to be part of a class of machinery known as “turbo machines” or “turbo rotating machines”.

Centrifugal compressors can he fitted with a single impeller, i.e., single stag e configuration, or with a plurality of impellers in series, in which case they are frequently referred to as multistage compressors. Each of the stages of a centrifugal compressor typically includes an inlet conduit for gas to be compressed, an impeller which is capable of imparting kinetic energy to the input gas and a diffuser which converts the kinetic energy of the gas leaving the rotor into pressure energy.

An impeller generally includes a plurality of blades which are disposed radially relative to one another to form a plurality of passages which converge toward the center of the impeller and through which, in operation, the compressible gas flows, The blades are connected on one end to a hub and, on the other end, to a shroud. Such impellers are subjected to significant stresses during operation, attributable to, for example, the high speeds at which they are rotated and the high densities at which the compressible gases are provided to the centrifugal compressors. Thus, it is important to design such impellers to withstand such stresses and operate stably for long periods of time.

The manner in which the blades are connected to the huh and shroud are, therefore, quite important to the overall design of the impeller and a number of different connection techniques have been used previously. It is not unusual for the blades to be milled together with the hub as one piece, and then to be connected to the shroud, e.g., by welding. For example, as shown in FIG. 1, an impeller blade 10 has a cross-sectional connection area which is generally triangular in shape, albeit with a small flattened portion near the tip, and is integrally formed with a hub 12. This blade 10 can be connected to a shroud 14 using an internal, manual arc welding technique. Therein five arc welding passes are made (as shown by zones 1-5) to weld the end of the blade 10 to the surface of the shroud 14. However, this connection process suffers from the common drawbacks of manual processes, e.g., lack of uniformity in the welds and cost inefficiencies, the former resulting in connection deformation defects that prevent the impeller from withstanding operational stresses due to geometrical variances in the blade created by the manual welding connection process. The final shape of the blade after it is connected to the shroud using manual arc welding will thus vary from blade to blade within the impeller.

Automated, external connection techniques have also been proposed. For example, as shown in FIG. 2, an automated tungsten inert gas (TIG) welding process can be used to attach a blade 20 to shroud 22, in this connection mechanism, a slot 24 is formed in the shroud 22. which is initially covered by a relatively thin metal portion or membrane 26, In this technique, it can be seen that the connection area of the blade 20 has a generally rectangular cross-sectional shape. The weld is performed through a series of welding passes (labeled as zones 1-7 in FIG. 2) from the outside of the shroud 22, the first of which melts the thin metal portion 26, and the remainder of which fill in the slot 24. This welding process is also intended to generate a fillet radius (curved connection areas) between the blade 20 and the shroud 22. However, since the welding process itself is intended to generate the curved areas on either side of the blade 20, the result is inherently non-uniform fillet radii as between the various blades within the impeller.

Electron beam and laser beam welding techniques have also been used to connect impeller blades to the shroud. As shown in FIG. 3, a blade 30, which is milled onto the hub 32 and has a typical rectangular-shaped connection area cross section, can be welded to the shroud 34 by directly applying the electron beam or laser beam through the shroud 34 to the connection area of the blade 30 and melting the blade 30 onto the shroud 34. However, this approach also suffers from a number of drawbacks. For example, in the connection area between the blade 30 and the shroud 34, there are no fillet radii generated by this welding processing, i.e., the edges of the blade 30 remain straight and perpendicular relative to the surface of the shroud. Moreover, there is no penetration of the blade 30's connection area into the shroud 34, resulting in incomplete welds. From a production perspective, such incomplete welds make historical electron beam or laser beam welding techniques inappropriate for manufacturing impellers. Another drawback of these techniques is the lack of precision associated with the welding process which makes it difficult to provide the weld directly in the center of the blade tip, thereby creating additional defects in the joint, This problem becomes more significant as the complexity of the blade shape, e.g., curves and twists, increases.

Brazing techniques have also been used, either by themselves or in conjunction with beam welding techniques, to attach impellers to other surfaces. However these techniques also suffer from the lack of penetration, lack of fillet radii and incomplete welding issues described above. Moreover, the joint created using brazing techniques is not resulting in potentially reduced mechanical characteristics of the joint, especially in operating conditions which include corrosive gases that may attack the brazing material.

Accordingly, it would be desirable to design and provide techniques for electron beam/laser beam welding of impeller blades to other surfaces, e.g., shrouds, which overcome the aforementioned drawbacks of existing welding techniques.

### BRIEF SUMMARY OF THE INVENTION

Exemplary embodiments relate to systems and methods for enabling automated beam welding techniques to he used for joining an impeller blade to. e.g., a shroud. According to one exemplary embodiment, a connection area of the impeller blade has a “hammer”-shaped cross-sectional area which facilitates beam welding of the connection area to a slot in the surface or body to which the blade is to be connected.

According to an exemplary embodiment, a method for beam welding an impeller blade to a surface includes the steps of inserting an impeller blade connection area into a slot in the surface, performing a first beam welding pass on a first side of the impeller blade connection area to weld the first side of the impeller blade connection area to one side of the slot, and performing a second beam welding pass on a second side of the impeller blade connection area to weld the second side of the impeller blade connection area to another side of the slot.

According to another exemplary embodiment, an impeller includes a hub having a plurality of impeller blades milled therein, and a shroud having slots formed therein and connected to each of the plurality of impeller blades at impeller blade connection areas by beam welding of each of two sides Of the impeller blade connection areas to corresponding sides of one of the slots.

According to yet another exemplary embodiment, a turbo machine includes a rotor assembly including at least one impeller, a bearing connected to, and for rotatable supporting, the rotor assembly, and a stator, wherein the at least one impeller includes a huh having a plurality of impeller blades milled therein, and a shroud having slots formed therein and connected to each of the plurality of impeller blades at impeller blade connection areas by beam welding of each of two sides of the impeller blade connection areas to corresponding sides of one of the slots.

### BRIEF DESCRIPTION OF THE DRAWINGS

The accompanying drawings illustrate exemplary embodiments, wherein:

FIG. 1 illustrates a manual arc welding technique for an impeller blade;

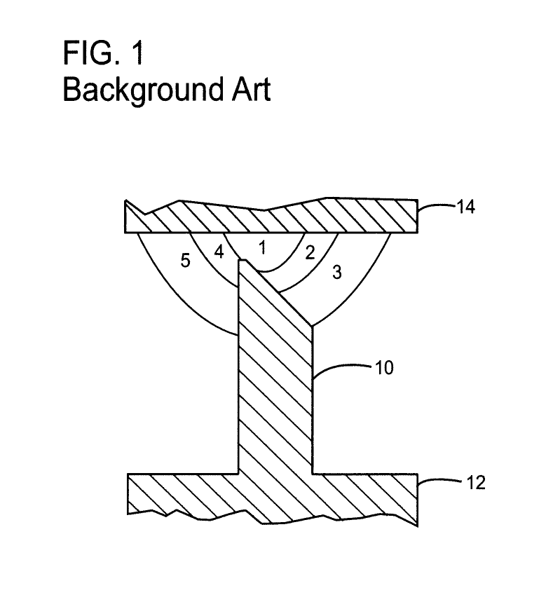

FIG. 2 depicts an automated, external welding technique for an impeller blade;

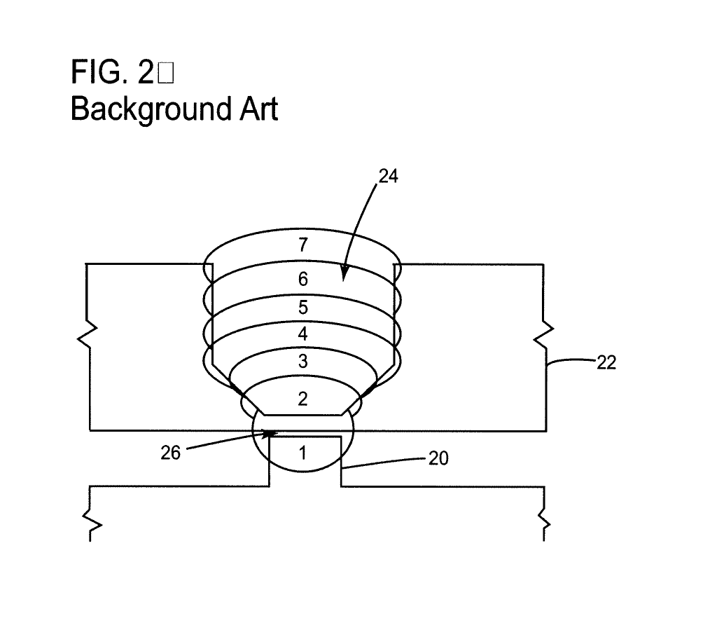

FIG. 3 shows a conventional beam welding technique for an impeller blade;

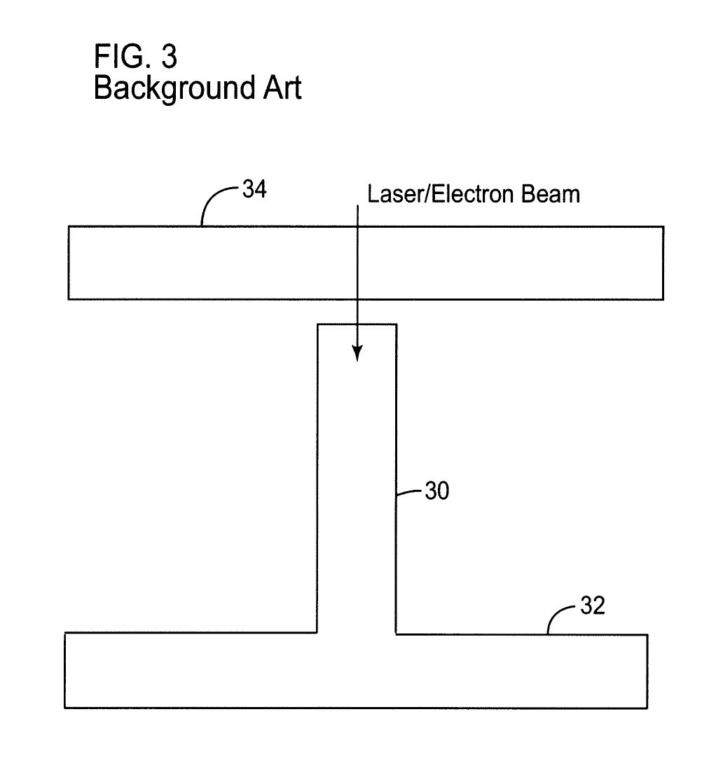

FIG. 4 depicts an exemplary centrifugal compressor in which impellers manufactured according to exemplary embodiments can be employed;

FIGS. 5 and 6 show an exemplary impeller which can be manufactured according to exemplary embodiments;

FIG. 7 depicts an impeller connection area and method for beam welding of an impeller to another surface according to an exemplary embodiment; and

FIG. 8 is a flowchart illustrating a method for welding an impeller to another surface according to an exemplary embodiment.

### DETAILED DESCRIPTION OF THE EXEMPLARY EMBODIMENTS OF THE INVENTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

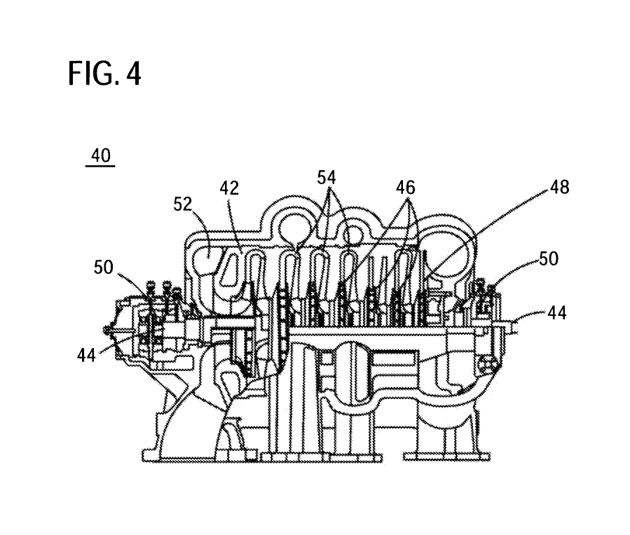

To provide some context for the subsequent discussion relating to welding techniques and impeller blade connection area shapes according to these exemplary embodiments, FIG. 4 schematically illustrates a multistage, centrifugal compressor 40 in which impellers fabricated using such techniques may be employed. Therein, the compressor 40 includes a box or housing (stator) 42 within which is mounted a rotating compressor shaft 44 that is provided with a plurality of centrifugal rotors or impellers 46. The rotor assembly 48 includes the shaft 44 and rotors 46 and is supported radially and axially through bearings 50 which are disposed on either side of the rotor assembly 48.

The multistage centrifugal compressor operates to take an input process gas from duct inlet 52, to accelerate the process gas particles through operation of the rotor assembly 48, and to subsequently deliver the process gas through various interstage ducts 54 at an output pressure which is higher than its input pressure. The process gas may, for example, be any one of carbon dioxide, hydrogen sulfide, butane, methane, ethane, propane, liquefied natural gas, or a combination thereof. Between the impellers 46 and the bearings 50, sealing systems (not shown) are provided to prevent the process gas from flowing to the bearings 50. The housing 42 is configured so as to cover both the bearings 50 and the sealing systems, so as to prevent the escape of gas from the centrifugal compressor 40.

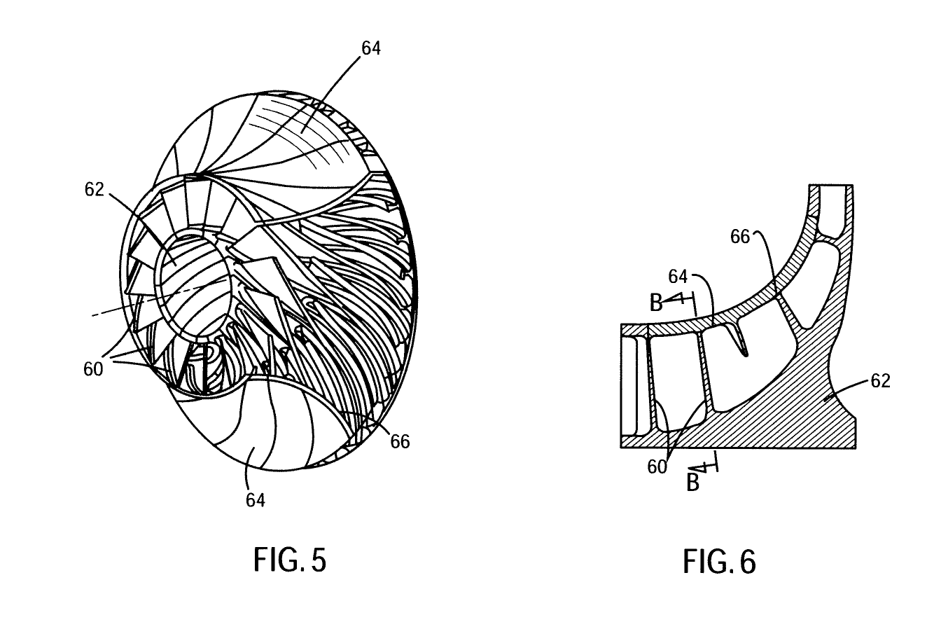

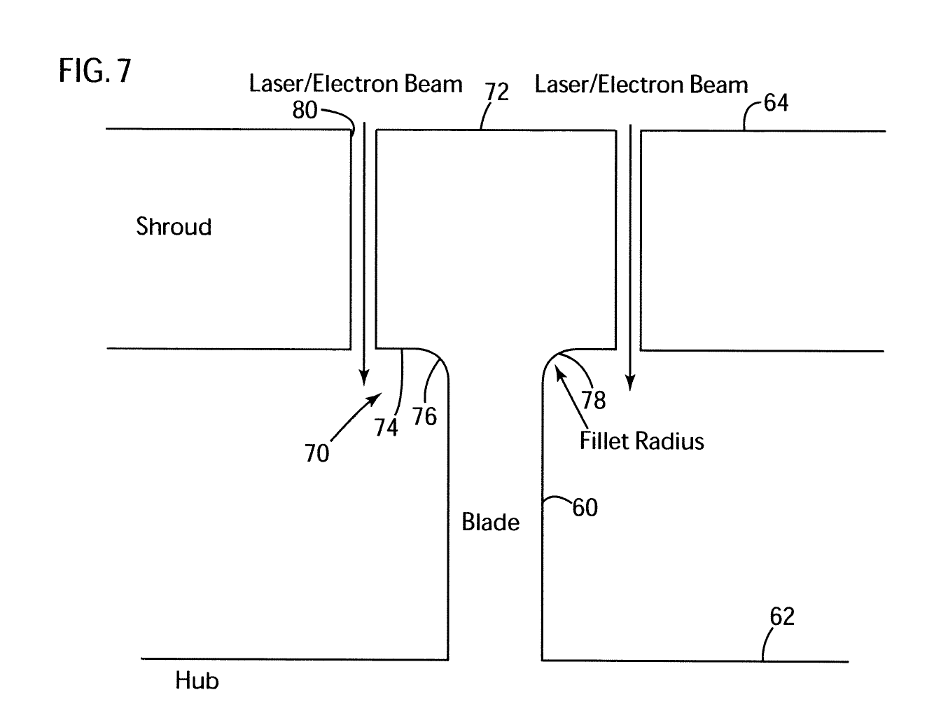

A more detailed, but purely exemplary, illustration of an impeller 46 is provided in FIG. 5. Therein it can be seen that the impeller 46 has a plurality of impeller blades 60 oriented radially between a hub 62 and a shroud 64 to which they are attached, e.g., at connection points 66. The exploded section of the impeller 46 reveals the twisted nature of the impeller blades 60 from the narrow end of the impeller 46 to its wider end. FIG. 6 is a partial cross-sectional view of the impeller 46 of FIG. 5 taken through the center of the impeller. Therein, the connection points 66 of the impeller blades 60 to the shroud 64 can be seen more clearly, and now the mechanisms by which such connections are formed according to exemplary embodiments will be described starting with FIG. 7, which is a cross-sectional view taken along the lines B-B in FIG. 6.

Therein, the “hammer”-like shape of the connection area 70 of impeller blades 60 according to exemplary embodiments is seen. Unlike other impeller blade connection areas described above, it can be seen that the connection area 70 is wider (thicker) from its outer end 72 to its inner end 74 relative to the next adjacent portion of the impeller blade 60. Additionally, at the inner end 74, the connection area 70 joins the rest of the blade 60 via curved sections 76 and 78. These curved sections 76 and 78 are designed with a predetermined radius of curvature (fillet radius) of e.g., 3-4 mm, to provide the attached impeller blade with desired strength and bending characteristics. Thus, the width (thickness) of the connection area 70 can, for example, be equal to the thickness of the blade 60 plus twice the desired fillet radius.

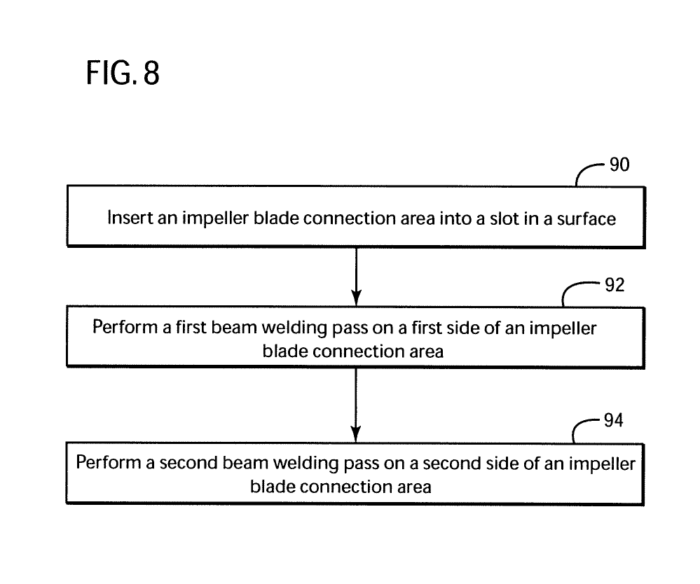

According to an exemplary embodiment, to attach impeller blade 60 to the shroud 64 the welding technique shown in the flowchart of FIG. 8 ay be performed. First, the connection area 70 of the impeller blade 60 is inserted into a corresponding slot 80 in the shroud 64, Then, a laser beam or electron beam welding machine (not shown in FIG. 6) generates a laser or electron welding beam in the (small) gap between a side of the connection area 70 and the side of the slot 80 in the shroud 64, and then repeats that process on the other side of the connection area 70, as represented by the two large arrows shown in FIG. 6 between the sides of the connection area and the sides of the slot in the shroud. The electron beam welding and/or laser beam welding equipment which is used to perform the welding passes themselves can be standard beam welding equipment as, for example, disclosed in U.S. Pat. Nos. 7,312,417 and 7,413,620, the disclosures of which are incorporated here by reference. This two pass beam welding process rapidly creates a solid connection joint on both sides of the connection area 70 to the shroud 64, without melting or otherwise impacting the fillet radii of the curved portions 76 and 78 or deforming the blade 60 because, among other things, the welds are performed along the sides of the connection area. 70 and do not modify the preformed fillet radii 76 and 78.

Thus, according to an exemplary embodiment, a method for beam welding an impeller blade to a surface, e.g., a shroud of an impeller, can include the steps illustrated in the flowchart of FIG. 7 Therein, at step 90, an impeller blade connection area is inserted into a slot in the surface. Then, at step 92, a first beam welding pass is performed on a first side of the impeller blade connection area to weld the first side of the impeller blade connection area to one side of the slot. Next, at step 94, a second beam welding pass is performed on a second side of the impeller blade connection area to weld the second side of the impeller blade connection area to another side of the slot.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for beam welding an impeller blade to a surface, the method comprising:
inserting an impeller blade connection area into a slot in said surface;
performing a first beam welding pass on a first side of said impeller blade connection area to weld said first side of said impeller blade connection area to one side of said slot; and
performing a second beam welding pass on a second side of said impeller blade connection area to weld said second side of said impeller blade connection area to another side of said slot.

2. The method of claim 1, wherein said beam welding process is one of a laser beam welding process and an electron beam welding process.

3. The method of claim 1, wherein said impeller blade connection area has a hammer-shaped cross sectional area which is wider, from a first end thereof which is inserted into said slot to a second end thereof, than an adjacent portion of said impeller blade.

4. An impeller comprising:
a hub having a plurality of impeller blades milled therein; and
a shroud having slots formed therein and connected to each of said plurality of impeller blades at impeller blade connection areas by beam welding of each of two sides of said impeller blade connection areas to corresponding sides of one of said slots.

5. The impeller of claim 4, wherein said beam welding is one of a laser beam welding process and an electron beam welding process.

6. The impeller of claim 4, wherein said impeller blade connection area has a hammer-shaped cross sectional area which is wider, from a first end thereof which is inserted into a corresponding slot to a second end thereof, than an adjacent portion of said impeller blade.

7. The impeller of claim 4, wherein said impeller blade connection area further comprises:
two curved sections which connect said impeller blade connection area to said adjacent portion of said impeller blade, wherein said two curved portions each have a predetermined radius of curvature and are not impacted by said first and second beam welding passes.

8. A turbo machine comprising:
a rotor assembly including at least one impeller;
a bearing connected to, and for rotatable supporting, the rotor assembly; and
a stator,
wherein said at least one impeller includes:
a hub having a plurality of impeller blades milled therein; and
a shroud having slots formed therein and connected to each of said plurality of impeller blades at impeller blade connection areas by beam welding of each of two sides of said impeller blade connection areas to corresponding sides of one of said slots.

9. The turbo machine of claim 8, wherein said impeller blade connection area has a hammer-shaped cross sectional area, which is wider, from a first end thereof which is inserted into a corresponding slot to a second end thereof, than an adjacent portion of said impeller blade.

10. The turbo machine of claim 8, wherein said impeller blade connection area further comprises:
two curved sections which connect said impeller blade connection area to said adjacent portion of said impeller blade.
